(19) United States
(12) Patent Application Publication
(10) Pub. No.: US 2025/0196477 A1
(43) Pub. Date: Jun. 19, 2025

(54) MULTILAYER FILMS COMPRISING IONOMERS OF ETHYLENE ACID POLYMERS

(71) Applicants: Dow Global Technologies LLC, Midland, MI (US); Dow Quimica De Colombia S.A., Bogota (CO)

(72) Inventors: Jorge Mario Rodriguez Camelo, Bogota (CO); Stephen L. Kodjie, Lake Jackson, TX (US); Akanksha Garg, Pearland, TX (US); Rajesh P. Paradkar, Lake Jackson, TX (US); Jesus Nieto Palomo, Tarragona (ES); Arnaldo T. Lorenzo Loreto, Manvel, TX (US)

(21) Appl. No.: 18/847,749

(22) PCT Filed: May 19, 2023
(86) PCT No.: PCT/US2023/022827

§ 371 Date: Sep. 17, 2024

Related U.S. Application Data
(60) Provisional application No. 63/365,085, filed on May 20, 2022.

(51) Int. Cl. B32B 27/08; B32B 7/02; B32B 27/32

(52) U.S. Cl. CPC B32B 27/08; B32B 7/02; B32B 27/32; B32B 2250/05; B32B 2250/242; B32B 2250/40; B32B 2270/00; B32B 2307/54; B32B 2307/558; B32B 2307/5825; B32B 2307/704; B32B 2307/72; B32B 2307/7376

(57) ABSTRACT

Provided are multilayer films including zinc or sodium ionomers of ethylene acid copolymer. The multilayer films can be fully compatible with polyethylene recycling streams. The multilayer films include a first outer layer, a second outer layer, and a core, the core including a first core layer that includes a zinc or sodium ionomer of ethylene acid copolymer. The multilayer films of the present invention can exhibit improved, maintained, or desirable properties, such as high tear resistance, in comparison to existing multilayer film structures.

### TECHNICAL FIELD

Embodiments of the present disclosure generally relate to multilayer films, and more particularly relate to multilayer films including zinc or sodium ionomers of ethylene acid copolymer.

### INTRODUCTION

An increasingly relevant problem in the packaging industry is the abundance of packaging waste and inflexible packaging with a poor balance of stiffness and toughness. Multilayer films that incorporate a variety of materials, including polypropylene, polyamide, and polyethylene terephthalate, contribute to bulky packaging in industrial and consumer products. Such films used often require sufficient toughness and tear resistance—for example, to avoid the film from breakage during the film wrapping process on a pallet. The combination of layers and materials can allow for good performance of the films, but such multilayer films can lack a balance of stiffness and toughness and can be difficult, if not impossible, to recycle together due to the different types of materials that are not recycle-compatible with each other. As demand for less bulky, mono-material recyclable materials continues to rise, there remains a need for multilayer films that can be recycled more easily and that exhibit a balance of desirable properties, such as tear resistance, toughness, and/or stiffness.

### SUMMARY

Embodiments of the present disclosure meet one or more of the foregoing needs by providing multilayer films that exhibit a desirable balance of tear resistance, toughness, and stiffness and include recycle-compatible ethylene-based polymers, including zinc or sodium ionomers of ethylene acid copolymer. The multilayer films can be fully recycle-compatible in polyethylene recycling streams, and the tear resistance and toughness performance of the inventive multilayer layer films can be comparable or better than other multilayer films.

Disclosed herein are multilayer films. In one aspect, a multilayer film comprises a first outer layer, a second outer layer, and a core, the core comprising one or more core layers, wherein a first core layer comprises from 5 to 45 wt. %, based on the total weight of the first core layer, of a zinc or sodium ionomer of ethylene acid copolymer and from 55 to 95 wt. %, based on the total weight of the first core layer, of a polyethylene having a density of from 0.950 to 0.970 g/cm³ and a melt index (I₂) of from 0.3 to 10.0 g/10 min; wherein the first core layer has a thickness of 5 to 40% of the total thickness of the multilayer film.

Also disclosed herein are articles. An article can comprise a multilayer film according to embodiments disclosed herein.

These and other embodiments are described in more detail in the Detailed Description.

### DETAILED DESCRIPTION

Aspects of the disclosed multilayer films are described in more detail below. The multilayer films can have a wide variety of applications, including, for example, cast stretch films, blown films, oriented films, stretch hood films, heavy duty shipping sacks, or the like. This disclosure, however, should not be construed to limit the embodiments set forth below as this disclosure is an illustrative implementation of the embodiments described herein.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “copolymer” means a polymer formed by the polymerization reaction of at least two structurally different monomers. The term “copolymer” is inclusive of terpolymers.

As used herein, the terms “polyethylene” or “ethylene-based polymer” shall mean polymers comprising a majority amount (>50 wt. %) of units which have been derived from ethylene monomer. This includes polyethylene homopolymers and copolymers (meaning units derived from two or more comonomers). Unless expressly stated otherwise, the ethylene copolymers disclosed herein (e.g., the zinc or sodium ionomer of ethylene acid copolymer described herein) are ethylene-based polymers.

Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and include the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers.

As used herein, the term “a zinc or sodium ionomer of ethylene acid copolymer” means an ionomer including an ethylene acid copolymer having carboxylic acid groups neutralized as carboxylic acid salts comprising zinc or sodium cations, wherein the ethylene acid copolymer is the polymerized reaction product of greater than 50 wt. % ethylene monomer and greater than 2 wt. % monocarboxylic acid monomer, based on the total weight of monomers present in the ethylene acid copolymer.

As used herein, the term “core layer” refers to a non-skin or non-outer layer of a multilayer film. A core layer is an internal layer, i.e., a layer positioned between two outer layers, of a multilayer film. In one embodiment, a first core layer is the non-outer layer of a three-layer film that comprises a first outer layer and a second outer layer. The totality of core layers in the multilayer film of this invention, i.e., one or a plurality, constitute the “core” of the film.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Disclosed herein are multilayer films. In some embodiments, the multilayer film can be an oriented film that is oriented in the machine and/or cross direction. In some embodiments, the multilayer film is a blown film. In other embodiments, the multilayer film is a cast stretch film. In further embodiments, the multilayer film is a stretch hood film.

The multilayer films according to embodiments disclosed herein comprise a first outer layer, a second outer layer, and a core, the core comprising one or more core layers. The core is positioned between the first outer layer and the second outer layer. The core comprises a first core layer that comprises a zinc or sodium ionomer of ethylene acid copolymer and a polyethylene.

### First Outer Layer and Second Outer Layer of Multilayer Film

The first outer layer and the second outer layer of the multilayer film are not particularly limited. The first outer layer and the second outer layer can have the same polymer composition or different polymer composition. In some embodiments, each of the first outer layer and the second outer layer have a thickness that is 5 to 35% of the total thickness of the multilayer film.

In some embodiments, the first outer layer and the second outer layer each comprise polyethylene. In some embodiments, the first outer layer and/or the second outer layer comprise an ethylene-based polymer such as an ULDPE, LLDPE, LDPE, MDPE, or HDPE. For example, in some embodiments, the first outer layer and/or the second outer layer comprise an ULDPE, LLDPE, an LDPE, or a blend thereof.

In embodiments where the first outer layer and/or the second outer layer comprise polyethylene, the polyethylene can have a density less than or equal to 0.940 g/cm³. All individual values and subranges less than or equal to 0.940 g/cm³ are included and disclosed herein; for example, the density of the polyethylene can be from a lower limit of 0.870, 0.880, 0.890, 0.910, 0.920 g/cm³ to an upper limit of 0.940, 0.935, 0.930 or 0.925 g/cm³. All individual values and subranges between 0.870 and 0.940 g/cm³ are included and disclosed herein.

In embodiments where the first outer layer and/or the second outer layer comprise polyethylene, the polyethylene can have a melt index (I₂) in the range of from 0.1 g/10 min to 50 g/10 min. All individual values and subranges of from 0.1 g/10 min to 50 g/10 min are disclosed and included herein. For example, the polyethylene can have a melt index (I₂) in the range of from 0.1 g/10 min to 40 g/10 min, 0.1 g/10 min to 30 g/10 min, 0.1 g/10 min to 20 g/10 min, 0.1 g/10 min to 10 g/10 min, or 0.1 g/10 min to 5 g/10 min.

Commercially available examples of polyethylene that can be used in the first outer layer and/or the second outer layer include those commercially available from The Dow Chemical Company under the name ATTANE™ including, for example, ATTANE™ 4404G, and those under the name INNATE™, including, for example, INNATE™ ST 50.

In some embodiments, the first outer layer and/or the second outer layer comprise an ULDPE. In embodiments where the first outer layer and/or the second outer layer comprise an ULDPE, the ULDPE can have a density less than or equal to 0.912 g/cm³. All individual values and subranges less than or equal to 0.912 g/cm³ are included and disclosed herein; for example, the density of the ULDPE can be from a lower limit of 0.855, 0.860, 0.870, 0.880, 0.890 g/cm³ to an upper limit of 0.912, 0.910, 0.908 or 0.906 g/cm³. All individual values and subranges between 0.855 and 0.912 g/cm³ are included and disclosed herein.

In embodiments where the first outer layer and/or the second outer layer comprise an ULDPE, the ULDPE can have a melt index (I₂) in the range of from 0.1 g/10 min to 50 g/10 min. All individual values and subranges of from 0.1 g/10 min to 50 g/10 min are disclosed and included herein. For example, the ULDPE can have a melt index (I₂) in the range of from 0.1 g/10 min to 40 g/10 min, 0.1 g/10 min to 30 g/10 min, 0.1 g/10 min to 20 g/10 min, 0.1 g/10 min to 10 g/10 min, or 0.1 g/10 min to 5 g/10 min.

### Core of Multilayer Film

The multilayer film comprises a core. The core comprises one or more core layers. In some embodiments, the core comprises 100 wt. % ethylene-based polymers, including a zinc or sodium ionomer of ethylene acid copolymer (described below), based on the total weight of the core. The core is positioned between the first outer layer and the second outer layer. The core comprises a first core layer. In some embodiments, the multilayer film disclose herein is a three-layer film comprising a first outer layer, a second outer layer, and a core, the core comprising a first core layer. In other embodiments, the multilayer film comprises at least five layers. For example, in some embodiments, the core comprises a first core layer, a second core layer, and a third core layer, wherein the first core layer is positioned between the first outer layer and the third core layer, the second core layer is positioned between the third core layer and the second outer layer, and the third core layer is positioned between the first core layer and the second core layer (i.e., First Outer Layer/First Core Layer/Third Core Layer/Second Core Layer/Second Outer Layer). In embodiments where the core comprises a first core layer, a second core layer, and a third core layer, the multilayer film comprises at least five layers.

The core comprises a first core layer. The first core layer comprises from 5 to 45 wt. %, based on the total weight of the first core layer, of a zinc or sodium ionomer of ethylene acid copolymer and from 55 to 95 wt. %, based on the total weight of the first core layer, of a polyethylene having a density of 0.950 to 0.970 g/cm³ and a melt index (I₂) of from 0.3 to 10.0 g/10 min. The first core layer has a thickness of 5 to 40% of the total thickness of the multilayer film.

The first core layer comprises 5 to 45 wt. % of a zinc or sodium ionomer of ethylene acid copolymer, based on the total weight of the first core layer. All individual value and subranges of 5 to 45 wt. % are disclosed and incorporated herein. For example, the first core layer can comprise from a lower limit of 5, 10, 15, 20, or 22 wt. % to an upper limit of 27, 30, 35, 40, or 45 wt. % of a zinc or sodium ionomer of ethylene acid copolymer, based on total weight of the first core layer.

In some embodiments, the first core layer comprises a zinc ionomer of ethylene acid copolymer. In other embodiments, the first core layer comprises a sodium ionomer of ethylene acid copolymer. In some embodiments, the zinc or sodium ionomer of ethylene acid copolymer has a density in the range of from 0.940 to 0.960 g/cm³, or from 0.945 to 0.955 g/cm³. In some embodiments, the zinc or sodium ionomer of ethylene acid copolymer has a melt index (I₂) of less than 3.0 g/10 min, or less than 2.0 g/10 min, or less than 1.0 g/10 min.

A commercially available example of a sodium ionomer of ethylene acid copolymer that can be used in the first core layer and/or second core layer includes SURLYN™ 1707. A commercially available example of a zinc ionomer of ethylene acid copolymer that can be used in the first core layer and/or second core layer includes SURLYN™ 1706.

The first core layer comprises 55 to 95 wt. %, based on total weight of the first core layer, of a polyethylene having a density of 0.950 to 0.970 g/cm³ and a melt index (I₂) of from 0.3 to 10.0 g/10 min. All individual values of from 55 to 95 wt. % are disclosed and included herein. For example, the first core layer can comprise from a lower limit of 60, 65, 70, 72, or 73 wt. % to an upper limit of 78, 80, 85, 90, or 95 wt. % of a polyethylene, based on total weight of the first core layer.

The polyethylene of the first core layer has a density of from 0.950 to 0.970 g/cm³. In one or more embodiments, the polyethylene of the first core layer is a HDPE (high density polyethylene). All individual values and subranges are disclosed and included herein. For example, the polyethylene of the first core layer can have a density with a lower limit of 0.950, 0.952, 0.954, 0.956, 0.958, or 0.960 g/cm³ and an upper limit of 0.970, 0.968, 0.966, 0.965, or 0.964 g/cm³. The polyethylene of the first core layer has a melt index (I₂) of from 0.3 to 10.0 g/10 min. All individual values and subranges are disclosed and included herein. For example, the polyethylene of the first core layer can have a melt index (I₂) with a lower limit of 0.3, 0.4, 0.5, 0.6, 1.0, 2.0, 3.0, 4.0, 5.0, 6.0, or 7.0 g/10 min and an upper limit of 10.0, 9.0, 8.5, 7.0, 6.0, 5.0, 4.0, 3.0, 2.0, or 1.0 g/10 min.

Commercially available examples of a polyethylene that can be used in the first core layer and/or second core layer include those commercially available from The Dow Chemical Company under the name ELITE™ 5960G1 and DOW™ DMDA-8007 NT 7.

In some embodiments, the first core layer has a Raman measured % crystallinity of from 50% to 63%. Raman crystallinity can be measured in accordance with the test method described below.

In some embodiments, the multilayer film comprises a second core layer. In some embodiments, the second core layer has the same polymer composition as the first core layer. In other embodiments, the second core layer has a different polymer composition than the first core layer. In some embodiments, a second core layer comprises from 5 to 45 wt. % of a zinc or sodium ionomer of ethylene acid copolymer and from 55 to 95 wt. % of a polyethylene having a density of 0.950 to 0.970 g/cm³, based on the total weight of the second core layer. The polyethylene and the zinc or sodium ionomer of ethylene acid copolymer of the second core layer can have the same density and melt index (I₂) parameters as the polyethylene and ionomer of the first core layer.

In some embodiments, the multilayer film comprises a third core layer. In such embodiments, the third core layer is positioned between the first core layer and the second core layer and comprises a polyethylene having a melt index less than 7.0 g/10 min and density less than 0.940 g/cm³. The polyethylene of the third core layer can have a melt index of less than 7.0 g/10 min, or less than 6.0 g/10 min, or less than 5.0 g/10 min. The polyethylene of the third core layer can have a density of less than 0.940 g/cm³, or less than 0.930 g/cm³, or less than 0.925 g/cm³.

### Additives

It should be understood that any of the foregoing layers can further comprise one or more additives as known to those of skill in the art such as, for example, antioxidants, ultraviolet light stabilizers, thermal stabilizers, slip agents, antiblock agents, antistatic agents, pigments or colorants, processing aids, crosslinking catalysts, flame retardants, fillers and foaming agents. For example, in some embodiments, the first outer layer and the second outer layer each comprise an antiblock agent.

### Multilayer Films

Multilayer films disclosed herein can be produced using techniques known to those of skill in the art based on the teachings herein. For example, the multilayer film may be produced by coextrusion. The formation of coextruded multilayer films is known in the art and applicable to the present disclosure. Coextrusion systems for making multilayer films employ at least two extruders feeding a common die assembly. The number of extruders is dependent upon the number of different materials or polymers comprising the coextruded film. For example, a five-layer coextrusion may require up to five extruders although less may be used if two or more of the layers are made of the same materials or polymers.

The multilayer film of the present invention, in various embodiments, can have several desirable properties. Without being bound by any theory, the specific structure of the multilayer film, along with the inclusion of the specific polyethylene and zinc or sodium ionomer of ethylene acid copolymer in the core, can create a particular layer morphology in the multilayer film that promotes higher absorption of energy when the structure is mechanically required, resulting in the multilayer film having desirable tear resistance, toughness, and/or stiffness properties.

In some embodiments, the multilayer film has a thickness between 6 and 150 microns, or alternatively between 6 and 100 microns, or alternatively between 6 and 50 microns.

In some embodiments, the multilayer film of the present invention comprises at least 90 wt. % ethylene-based polymer, or at least 95 wt. % ethylene-based polymer, or at least 99 wt. % ethylene-based polymer, or at least 99.5 wt. % ethylene-based polymer, or at least 99.9 wt. % ethylene-based polymer, based on the overall weight of the multilayer film. Because the multilayer films in some embodiments comprise at least 90 wt. % ethylene-based polymer, they can be compatible with polyethylene recycling streams. In some embodiments, the multilayer film consists essentially of 100 wt. % ethylene-based polymer, based on total weight of the multilayer film.

In some embodiments, the multilayer film is a machine direction oriented film. In other embodiments, the multilayer film is a cast stretch film. In further embodiments, the multilayer is a blown film.

### Cast Stretch Film and Blown Film

In one embodiment, the multilayer film of the present invention is a cast stretch film. Cast stretch films are high clarity films utilized to protect and unitize manufactured goods or items for transport and storage. It is highly desirable for cast stretch films to have high cross directional tear strength to minimize catastrophic failures during on pallet wrapping. Cast stretch film can be differentiated from blown stretch film by the method of fabrication. The major differences between cast and blown films are related to cooling methods, film orientation, line speed and gauge control. Cast films typically exhibit better optical properties and a much higher degree of machine direction orientation as compared to blown film. Cast stretch films can be produced using techniques known to those of skill in the art based on the teachings herein.

In embodiments where the multilayer film is a cast stretch film, the cast stretch film can have an ESTL tear greater than 0.4 s/micron. ESTL tear can be measured in accordance with the test method described below. The ESTL tear measurement of time to propagate in seconds(s) can be divided by the thickness of the film in micron to provide a s/micron measurement.

In one embodiment, the multilayer film of the present invention is a blown film. The blown film can be made by methods known in the art. In embodiments where the multilayer film is a blown film, the blown film can have at least one of the following properties: a machine direction Elmendorf Tear Strength greater than 0.13 N/micron and/or a Dart Drop Impact B greater than 0.031 N/micron. Machine direction Elmendorf Tear Strength and Dart Drop Impact B can be measured in accordance with the test methods described below.

### Articles

Embodiments of the present invention also provide articles including any of the inventive multilayer films described herein. Examples of such articles can include wraps, packages, flexible packages, pouches, and sachets. Articles of the present invention can be formed from the multilayer films disclosed herein using techniques known to those of skill in the art in view of the teachings herein.

### Test Methods

### Density

Density is measured in accordance with ASTM D792, and expressed in grams/cm³ (g/cm³).

### Melt Index (I₂)

Melt index (I₂) is measured in accordance with ASTM D-1238 at 190° C. at 2.16 kg. The values for melt index are reported in g/10 min, which corresponds to grams eluted per 10 minutes.

### Raman Microscopy

Raman microscopy and multivariate calibration is used to measure the % crystallinity of individual layers of the multilayer film. Raman microscopy, a type of vibrational spectroscopic technique, is sensitive to vibrations of the polymer backbone and can provide information on both the amorphous and crystalline phases of a polymer and polyethylene compositions. Raman can use visible or near-infrared radiation and when coupled with an optical microscope provides a lateral spatial resolution of approximately 0.8 to 1.2 micrometers (depending on the excitation laser and microscope objective used).

A Partial Least Square (PLS) model is built to correlate Raman data with the (%) crystallinity calculated from the annealed polyethylene density. This model is then used to predict % crystallinity of each layer in the multilayer film. Annealed density is measured in accordance with ASTM D792. Percent (%) crystallinity is calculated from the measured annealed density using the following equation (Equation 1):

$$wt \% Cryst . = \frac{{ρ}_{c}}{ρ} ( \frac{ρ - {ρ}_{a}}{{ρ}_{c} - {ρ}_{a}} ) \qquad ( Eq . 1 )$$

Where: ρₐ=0.855 g/cc (100% amorphous) and ρ_{c}=1.000 g/cc (100% crystalline) densities.

Depolarized Raman spectra are acquired using equivalent Thermo Scientific DXR2 micro-Raman instruments. Raman spectra are acquired using a 900 grooves/mm grating. Spectral range covered a Raman shift from 50 to 3500 cm⁻¹, with a data spacing of 0.964 cm⁻¹. Other data acquisition parameters are as follows. Acquisition time: 3-10 sec; Number of acquisitions: 3 to 6; dark current subtraction, cosmic ray filter and white light correction: turned ON. Calibration data were recorded with an Olympus M PlanN 100× (0.90 NA) objective using a 50 micrometer pinhole.

Twenty-eight polyethylene composition resins ranging in density from 0.859-0.964 g/cm³ are used for calibration and cross-validation of the PLS model. The PLS model is also validated using an independent set of density plaques and then used to measure the resin crystallinity of resins used in the individual layers of the multilayer film. The PLS model is built with TQ Analyst™ software using the following parameters: Spectral Region: 1571 cm¹ to 971 cm⁻¹; Normalization: Integrated Area 1356-1227 cm⁻¹-same baseline points; Total number of samples: 28; #Calibration standards: 26; #Independent Cross validation samples: 2; #Independent Validation samples: 6; Data pre-processing for: Annealed Base resin density model and Calc. % Crystallinity model-Mean centering, 2^{nd} derivative, SG smoothing (15 point, 3^{rd} order polynomial); Number of Factors Used for Calibration of both models: Annealed Base resin density and calc. % crystallinity=4.

After validation of the PLS model, a cross section of the multilayer film is prepared via cryo-microtomy. Depolarized Raman spectra are acquired in five different locations within each layer using a 100× (0.9NA) objective and 25 micrometer pinhole. The resulting Raman spectra from each layer are averaged and the average spectrum is used to measure the layer % crystallinity using the PLS model.

### Ultimate Stretch

Ultimate stretch is measured using the Highlight Stretch Film Test Stand (Highlight Industries Wyoming, Michigan, U.S.A.). The film roll is placed on the unwind roller of the Highlight and wound through the equipment rollers as instructed on test procedure from Highlight. The ultimate stretch test is selected from the test menu and a method is selected (standard, heavy, light). The default is standard and should be used for most films. Heavy is for films thicker than 1 mil (25.4 μm) while the light method should be used for films below 50 gauge (˜12 μm) or films less than 15 inches wide. The method selected changes the ramp rate of the test. Once the method is selected the test is started and the film is stretched between the two pre-stretch rollers. Stretching is achieved through speed differential between the pre-stretch rollers. The film is stretched until an even break is observed between the two pre-stretch rollers. If the film break is not a straight line, or if the film breaks somewhere other than in between the pre-stretch rollers the failure is considered a bad break and not included in the data. The data reported on the graph is representative of the failure point however; a stretch force data point is picked as the stretch passes 200% stretch. The test is repeated a minimum of 3 times and an average US and SF is reported.

### On Pallet Puncture-Type A Load (OPP-A)

This test uses a Bruceton staircase method to determine the maximum force to load at which the film can be passed over a test probe for three wraps with no failures. The test probe is inserted into the test stand at the desired protrusion distance. The distance of the protrusion is determined by the thickness of the film. Thicker films are typically tested with a 12 inch protrusion and thinner films are tested at 5 inches. The film is positioned such that the test probe is aligned with the center of the film. The film is attached to the test stand and the wrapper started. Once the wrapper reaches 250% pre-stretch, the film is allowed to pass over the probe for a maximum of three wraps. The film is wrapped three times starting with a low F2 force of 7 lbs. If the film is not punctured by the probe, the test is repeated at an increased F2 force at increments of 0.5 lbs. until failure. At each 0.5 lb. increment the film is manually pushed over the probe and a fresh set of film is tested. Any breakage of the film during any of the wrap is considered a failure at that force to load setting. Depending on the performance of the film at the load setting (i.e., passed or failed), the force to load is adjusted up or down, and the test is repeated at the new load setting. This continues until the maximum force at which no failures are found. The failing F2 force represents the film's on-pallet puncture value and generally a standard deviation is not reported unless the test is repeated more than 2 times starting from 7 lbs. The highest passing F2 force is reported with data significance considered to be +/−1 lb. It should be understood that Type A Load Test is commonly used in pallet packing that a person of ordinary skill in the art would recognize its meaning as used herein. Table 8 provides the equipment and settings used in this method.

| | |
|---|---|
| Equipment | Lantech SHC Film Test Wrapper |
| Pre-stretch | 250% |
| Turntable Speed | 9 rpm |
| Force to Load (F2) | Variable |
| Probe Type | 4″ by 4″ blunt rod |
| Probe Protrusion Distance | 12 n |

### On Pallet Puncture—Type B (OPP B)

If unitized pallet is not uniform in shape with limited irregularities, it's defined as Type “B-Load”. This test uses a Bruceton staircase method to determine the maximum force to load at which the film can be passed over a test probe for three overlapping wraps with no failures. The test probe is inserted into the test stand at the desired protrusion distance. All films were tested by 2 inch×2 inch blunt metal probe extending 6 inches out. The film is positioned such that the test probe is aligned with the center of the film. The film is attached to the test stand and the wrapper started. Once the wrapper reaches 250% pre-stretch, the film is allowed to pass over the probe for a maximum of three wraps. The film is wrapped three times starting with post stretch film tension/force to load (F2) of 7 lbs. If the film is not punctured by the probe, the test is repeated at an increased F2 force at increments of 0.5 lbs. until failure. Any breakage of the film during any of the wrap is considered a failure at that force to load setting. Once the F2 force reaches a point where failures start to happen the test is repeated for 6 times at one force setting. If the film passes 4 of the 6 tests the film F2 force is increased. If the film fails 4 of the 6 tests then the test is stopped and this is considered the failure point of the film. Depending on the performance of the film at the load setting (i.e., passed or failed), the force to load is increased/decreased and the test is repeated at the new load setting. This continues until the maximum force at which no failure is observed. The highest passing F2 force is reported as On Pallet Puncture (OPP) value. Standard variation for this test is observed to be +/−1 lb. It should be understood that Type B Load Test is commonly used in pallet packing that a person of ordinary skill in the art would recognize its meaning as used herein. Table 9 below provides the equipment and settings used in this method.

| | |
|---|---|
| Equipment | Lantech SHC Film Test Wrapper |
| Pre-stretch | 250% |
| Turntable Speed | 9 rpm |
| Force to Load (F2) | Variable |
| Probe Type | 2″ by 2″ blunt rod |
| Probe Protrusion Distance | 6 in |

### On Pallet Tear

This test uses a Bruceton staircase method to determine the maximum force to load at which the film can be passed over a test probe fixed with a blade to initiate a puncture. The test probe is inserted into the test stand at the desired protrusion distance. The film is positioned such that the test probe is aligned with the center of the film. The film is attached to the test stand and the wrapper started. Once the wrapper reaches 250% pre-stretch, the film is allowed to pass over the probe, for this test a single layer of film is tested. The film tension (F2 force) is increased from an initial low value of ˜7 lbs. in increments of 0.5 lbs. until the film tears completely across the cross direction (CD) or transverse direction (TD). An on-pallet tear value is recorded as the highest F2 force that results in the initial puncture not propagating through the entire width of the film causing its failure. Table 10 provides the equipment and settings used in this method

| | |
|---|---|
| Equipment | Lantech SHC Film Test Wrapper |
| Pre-stretch | 250% |
| Turntable Speed | 9 rpm |
| Force to Load (F2) | Variable |
| Probe Type | 4″ by 4″ blunt rod fixed with a |
| | razor blade |
| Probe Protrusion Distance | 5 in |

### ESTL Tear

ESTL Tear is measured using an ESTL film performance tester (ESTL, Deerlijk, Belgium)—FPT-750 Film Property Tester. ‘Tear Propagation’ is selected from the test menu and the W-wrap method is then selected. The table below provides the parameters that are selected on the equipment to measure time-to-break (ESTL tear). The sample film is brought to a condition of pre-stretch and tension, followed by clamping of the film. A small ‘spear shaped knife’ is used to make a small vertical cut into the film. Once this cut has been made, the canvas unclamps the film. After one second the wind spindle starts to pull on the film with a constant speed. The other shafts are blocked. This generates a pulling force in the film after the initial cut. The FPT-750 Film Property Tester monitors how long it takes and how much force it takes to break open the full film height. The test is repeated 3 times and an average time-to-break is reported in seconds(s).

| | | |
|---|---|---|
| Strain Start | % | 250.0 |
| Line velocity | ft/min | 195 |
| Puncture Probe | | Propagation |
| Unwind tension | lbf | 6.70 |
| Wind strain | % | 10.0 |
| Stretch on loads | % | 285.0 |

### ASTM D882-2% Secant Modulus CD and MD

2% Secant Modulus in the cross direction (CD) and machine direction (MD) is measured in accordance with ASTM D882. This test covers the determination of the tensile, or extension, properties of plastics in the form of thin sheeting, including film, which is less than 1 mm (0.04 in) in thickness. Film is arbitrarily defined as having a nominal thickness not greater than 0.25 mm (0.010 in). Tensile properties may vary with specimen preparation, separation speed, and environment of testing. Therefore, for the most exacting comparison of two or more materials, all specimens should be prepared and tested in exactly the same way. The modulus of elasticity measurement is a special case of this test where, after the compensation has been applied, the modulus is calculated by dividing the tensile stress by the corresponding strain for the linear portion of the curve, or for an extension of the linear line. If there is no linear behavior, a tangent is drawn at the inflection point, to provide toe compensation by using the intersection of the tangent line with the strain axis as zero strain. The secant modulus can then be calculated as the ratio of stress to corrected strain at any point on the curve. Values for secant modulus are reported at 1, 2% strain, in both Machine (MD) and Cross-Machine (CD) directions.

### ASTM D1709—Dart Drop Impact

Dart Drop Impact B is measured in accordance with ASTM D1709. The film Dart Drop test determines the energy that causes plastic film to fail under specified conditions of impact by a free falling dart. The test result is the energy, expressed in terms of the weight of the missile falling from a specified height, which would result in failure of 50% of the specimens tested.

After the film is produced, it is conditioned for at least 40 hours at 23° C. (+/−2° C.) and 50% R.H (+/−5) as per ASTM standards. Standard testing conditions are 23° C. (+/−2° C.) and 50% R.H (+/−5) as per ASTM standards.

The test result can be reported by Method A, which uses a 1.5″ diameter dart head and 26″ drop height or Method B, which uses a 2.0 diameter dart head and 60″ drop height. The sample thickness is measured at the sample center and the sample then clamped by an annular specimen holder with an inside diameter of 5 inches. The dart is loaded above the center of the sample and released by either a pneumatic or electromagnetic mechanism.

Testing is carried out according to the ‘staircase’ method. If the sample fails, a new sample is tested with the weight of the dart reduced by a known and fixed amount. If the sample does not fail, a new sample is tested with the weight of the dart increased by a known amount. After 20 specimens have been tested the number of failures is determined. If this number is 10 then the test is complete. If the number is less than 10 then the testing continues until 10 failures have been recorded. If the number is greater than 10, testing is continued until the total of non-failures is 10. The Dart drop strength is determined from these data as per ASTM D1709 and expressed in grams as the dart drop impact of Type A. All the samples analyzed were 2 mil thick.

### Puncture Energy at Break

This test is based on ASTM D5748 Method for Protrusion Puncture Resistance of Stretch Wrap Films. A film specimen is held in a pneumatic clamp with a 4″ diameter opening while a probe moving a low rate (10 in/m) attempts to puncture the specimen. This method imparts a biaxial stress that is representative of the type of stress encountered in many end use applications for packaging film. Two probes are available for testing. The Dow Method probe is stainless steel with a round ½″ diameter head, while the ASTM probe is teflon coated stainless steel with a teardrop shape and a 0.75″ diameter shape as specified in ASTM D5748.

### ASTM D1922—Elmendorf Tear CD and MD

This test follows the ASTM D1922, where the force in grams required to propagate tearing across a film specimen is measured using a modified Pro-Tear Electronic Elmendorf Tear tester. Acting by gravity, the pendulum swings through an arc, tearing the specimen from a precut slit. The tear is propagated in the cross direction. This test can be measured both on the Machine (MD) and Cross-Machine (CD) directions.

### EXAMPLES

Table 1 below lists the materials that are included in the example multilayer films discussed below. With the exception of Braskem DS6D82, all of the materials listed below are ethylene-based polymers and are commercially available from The Dow Chemical Company (Midland, MI).

TABLE 1
List of Materials

| Name | Description | Density | Melt Index (I₂) |
|---|---|---|---|
| ATTANE ™ 4404G | Polyethylene - Ultra Low Density | 0.904 g/cm³ | 4.0 g/10 min |
| | Polyethylene Copolymer | | |
| ELITE ™ 5230 G | Polyethylene - Linear Low | 0.916 g/cm³ | 4.0 g/10 min |
| | Density Copolymer | | |
| DOW ™ DMDA- | Polyethylene - High Density | 0.965 g/cm³ | 8.3 g/10 min |
| 8007 NT 7 | Polyethylene | | |
| DOWLEX ™ 2027G | Polyethylene - Linear Low | 0.941 g/cm³ | 4.0 g/10 min |
| | Density Polyethylene | | |
| Braskem DS6D82 | Polypropylene | 0.900 g/cm³ | 7.0 g/10 min* |
| Entira AS MK 400 | Potassium Ionomer of Ethylene | 0.970 g/cm³ | 1.0 g/10 min |
| | Acid Copolymer | | |
| SURLYN ™ 1706 | Zinc Ionomer of Ethylene Acid | 0.950 g/cm³ | 0.75 g/10 min |
| | Copolymer | | |
| SURLYN ™ 1707 | Sodium Ionomer of Ethylene Acid | 0.950 g/cm³ | 0.9 g/10 min |
| | Copolymer | | |
| INNATE ™ ST50 | Polyethylene | 0.918 g/cm³ | 0.85 g/10 min |
| DOWLEX ™ | Polyethylene - Linear Low | 0.935 g/cm³ | 1.0 g/10 min |
| 2038.68G | Density Polyethylene | | |
| DOWLEX ™ 2050 | Polyethylene - High Density | 0.950 g/cm³ | 0.95 g/10 min |
| | Polyethylene | | |
| DOW ™ 132I LDPE | Polyethylene - Low Density | 0.921 g/cm³ | 0.25 g/10 min |
| | Polyethylene | | |
| ELITE ™ 5960G1 | Polyethylene - High Density | 0.962 g/cm³ | 0.85 g/10 min |
| | Polyethylene | | |
| INNATE ™ ST 70 | Polyethylene - Linear Low | 0.926 g/cm³ | 0.85 g/10 min |
| | Density Polyethylene | | |

*This value for Braskem DS6D82 is the melt flow of the polypropylene measured at 230° C./2.16 kg in accordance with ASMT D-1238.

### Cast Film Examples

Two sets of multilayer films are formed on a Dr Collin co-extrusion cast film line. For the first set, the Dr Collin co-extrusion film line has the following parameters-target film thickness: 15 μm; extruders: 5 extruders; layer configurations: A/B/C/D/E; layer distribution (%): 10/20/20/20/30; through put rate—550 kg/h; chill roll temperature—21° C.; die temperature—280° C.; air gap—5 mm; melt temperature of extruders A, B, C, D and E of 252° C., 197° C., 280° C., 280° C. and 280° C., respectively.

For the second set, the Dr Collin co-extrusion film line has the following parameters—target film thickness: 15 μm; extruders: 5 extruders; layer configurations: A/B/C/D/E; layer distribution (%): 10/15/30/15/30; through put rate—550 kg/h; chill roll temperature—21° C.; die temperature—280° C.; air gap—5 mm; melt temperature of extruders A, B, C, D and E of 255° C., 200° C., 280° C., 280° C. and 280° C., respectively.

For the first set, five-layer cast stretch films having a thickness of 15 microns are formed and designated as Inventive (Inv.) and Comparative (Comp.) Examples. Each of the example films has a structure of A/B/C/D/E, where A is the first outer layer, B is the first core layer, C is the third core layer, D is the second core layer, and E is the second outer layer. Table 2 reports the structure of the five-layer multilayer films that are formed. For each of these examples, the first outer layer has a thickness of 10% of the total thickness of the film; the first core layer has a thickness that is 20% of the thickness of the film; the third core layer has a thickness that is 20% of the thickness of the film; the second core layer has a thickness that is 20% of the thickness of the film; and the second outer layer has a thickness that is 30% of the thickness of the film.

TABLE 2
Five Layer Multilayer: First Set Film Structures

| Example | First Outer | First Core | Third Core | Second Core | Second Outer |
|---|---|---|---|---|---|
| (Ex.) | Layer | Layer | Layer | Layer | Layer |
| Comp. | 100 wt. % | 100 wt. % | 100 wt. % | 100 wt. % | 100 wt. % |
| Ex. 1 | ATTANE | ELITE ™ | ELITE ™ | ELITE ™ | ELITE ™ |
| | 4404G | 5230 G | 5230 G | 5230 G | 5230 G |
| Comp. | 100 wt. % | 100 wt. % | 100 wt. % | 100 wt. % | 100 wt. % |
| Ex. 2 | ATTANE | Braskem | ELITE ™ | ELITE ™ | ELITE ™ |
| | 4404G | DS6D82 | 5230 G | 5230 G | 5230 G |
| Comp. | 100 wt. % | 75 wt. % | 100 wt. % | 100 wt. % | 100 wt. % |
| Ex. 3 | ATTANE | DOWLEX ™ | ELITE ™ | ELITE ™ | ELITE ™ |
| | 4404G | 2027G + 25 wt. | 5230 G | 5230 G | 5230 G |
| | | % SURLYN ™ | | | |
| | | 1706 | | | |
| Comp. | 100 wt. % | 75 wt. % | 100 wt. % | 100 wt. % | 100 wt. % |
| Ex. 4 | ATTANE | ELITE ™ 5230 | ELITE ™ | ELITE ™ | ELITE ™ |
| | 4404G | G + 25 wt. % | 5230 G | 5230 G | 5230 G |
| | | SURLYN ™ 1706 | | | |
| Inv. | 100 wt. % | 75 wt. % DOW ™ | 100 wt. % | 100 wt. % | 100 wt. % |
| Ex. 1 | ATTANE | DMDA-8007 NT | ELITE ™ | ELITE ™ | ELITE ™ |
| | 4404G | 7 + 25 wt. % | 5230 G | 5230 G | 5230 G |
| | | SURLYN ™ 1706 | | | |

For the second set, five-layer cast stretch films having a thickness of 15 microns are formed and designated as Inventive (Inv.) and Comparative (Comp.) Examples. Each of the example films has a structure of A/B/C/D/E, where A is the first outer layer, B is the first core layer, C is the third core layer, D is the second core layer, and E is the second outer layer. Table 3 reports the structure of the five-layer multilayer films that are formed. For each of these examples, the first outer layer has a thickness of 10% of the total thickness of the film; the first core layer has a thickness that is 15% of the thickness of the film; the third core layer has a thickness that is 30% of the thickness of the film; the second core layer has a thickness that is 15% of the thickness of the film; and the second outer layer has a thickness that is 30% of the thickness of the film.

TABLE 3
Five Layer Multilayer: Second Set Film Structures

| Example | First Outer | First Core | Third Core | Second Core | Second Outer |
|---|---|---|---|---|---|
| (Ex.) | Layer | Layer | Layer | Layer | Layer |
| Comp. | 100 wt. % | 100 wt. % | 100 wt. % | 100 wt. % | 100 wt. % |
| Ex. 5 | ATTANE | ELITE ™ | ELITE ™ | ELITE ™ | ELITE ™ |
| | 4404G | 5230 G | 5230 G | 5230 G | 5230 G |
| Comp. | 100 wt. % | 100 wt. % | 100 wt. % | 100 wt. % | 100 wt. % |
| Ex. 6 | ATTANE | Braskem | ELITE ™ | Braskem | ELITE ™ |
| | 4404G | DS6D82 | 5230 G | DS6D82 | 5230 G |
| Comp. | 100 wt. % | 75 wt. % | 100 wt. % | 75 wt. % | 100 wt. % |
| Ex. 7 | ATTANE | DOWLEX ™ | ELITE ™ | DOWLEX ™ | ELITE ™ |
| | 4404G | 2027G + 25 wt. | 5230 G | 2027G + 25 wt. | 5230 G |
| | | % SURLYN ™ | | % SURLYN ™ | |
| | | 1706 | | 1706 | |
| Comp. | 100 wt. % | 75 wt. % | 100 wt. % | 75 wt. % | 100 wt. % |
| Ex. 8 | ATTANE | ELITE ™ 5230 | ELITE ™ | ELITE ™ 5230 | ELITE ™ |
| | 4404G | G + 25 wt. % | 5230 G | G + 25 wt. % | 5230 G |
| | | SURLYN ™ 1706 | | SURLYN ™ 1706 | |
| Inv. | 100 wt. % | 75 wt. % DOW ™ | 100 wt. % | 75 wt. % DOW ™ | 100 wt. % |
| Ex. 2 | ATTANE | DMDA-8007 NT | ELITE ™ | DMDA-8007 NT | ELITE ™ |
| | 4404G | 7 + 25 wt. % | 5230 G | 7 + 25 wt. % | 5230 G |
| | | SURLYN ™ 1706 | | SURLYN ™ 1706 | |

The thickness, ultimate stretch, ESTL tear (time to propagate), On-pallet tear, On-pallet puncture—Type A Load (OPP-A), and On-pallet puncture—Type B Load (OPP-B) are measured for each of the Comparative and Inventive Examples. Table 4 below provides the results for the first set of example films. Table 5 below provides the results for the second set of example films. As can be seen from Table 4 below, Inventive Example 1 which comprises 100 wt. % ethylene-based polymers and can be compatible with polyethylene recycling streams has a significantly better ESTL tear and on-pallet tear than Comparative Examples 1, 3, and 4. While Comparative Example 2 has a better ESTL tear and on-pallet tear, it comprises a mixture of polypropylene and polyethylene. Inventive Example 1 has desirable ultimate stretch and on-pallet puncture. As can be seen from Table 5 below, Inventive Example 2 which comprises 100 wt. % ethylene-based polymers and can be compatible with polyethylene recycling streams has a better ESTL tear than Comparative Examples 5, 7, and 8. Comparative Example 6 has a higher ESTL tear that Inventive Example 2, and it comprises a mixture of polypropylene and polyethylene. Inventive Example 2 has desirable ultimate stretch and on-pallet puncture.

TABLE 4
Properties of Five-layer: First Set Cast Stretch Film Examples

| | Comp. | Comp. | Comp. | Comp. | Inv. |
|---|---|---|---|---|---|
| | Ex. 1 | Ex. 2 | Ex. 3 | Ex. 4 | Ex. 1 |
| Thickness | 15 | 15 | 15 | 15 | 15 |
| (microns) | | | | | |
| Ultimate | 330 | 363 | 370 | 350 | 363 |
| Stretch (%) | | | | | |
| ESTL tear | 5.54 | 16.60 | 6.7 | 2.44 | 10.53 |
| (seconds) | | | | | |
| On-Pallet Tear | 9.33 | 14.5 | 11.67 | 9.5 | 12.17 |
| (lbs) | | | | | |
| OPP-B | 13 | 13.8 | 14 | 12.8 | 12 |
| OPP-A | 9 | 12 | 11.3 | 13.3 | 9.5 |

TABLE 5
Properties of Five-layer: Second Set Cast Stretch Film Examples

| | Comp. | Comp. | Comp. | Comp. | Inv. |
|---|---|---|---|---|---|
| | Ex. 5 | Ex. 6 | Ex. 7 | Ex. 8 | Ex. 2 |
| Thickness | 15 | 15 | 15 | 15 | 15 |
| (microns) | | | | | |
| Ultimate | 330 | 390 | 363 | 343 | 383 |
| Stretch (%) | | | | | |
| ESTL tear | 5.54 | 24.3 | 21.4 | 1.51 | 24.5 |
| (seconds) | | | | | |
| On-Pallet Tear | 9.33 | 21.80 | 12.30 | 8.17 | 12.00 |
| (lbs) | | | | | |
| OPP-B | 13.0 | 13.0 | 12.5 | 11.8 | 11.8 |
| OPP-A | 9.0 | 14.5 | 14.7 | 15.3 | 15.3 |

### Blown Film Examples

Multilayer films are formed on a Dr Collin blown film line with 5 extruders. The Dr Collin blown film line has the following parameters: Layer distribution (%): 33/12/10/12/33 (for Comparative Example 14) and 30/15/10/15/30 (for the rest of the Examples); Takeoff: 4.5 m/min; Blow-up Ratio—B.U.R.: 2.5; Die gap: 1.8 millimeters; Die Temperature—235° C.; melt temperatures of extruder A, B, C D, E are 235° C., 240° C., 234° C., 240° C., and 235° C., respectively.

Five-layer blown films are formed and designated as Inventive (Inv.) and Comparative (Comp.) Examples. Each of the example blown films has a structure of A/B/C/D/E, where A is the first outer layer, B is the first core layer, C is the third core layer, D is the second core layer, and E is the second outer layer. Table 6 reports the structure of the multilayer films that are formed. For each of these examples (with exception to Comparative Example 14), the first outer layer has a thickness of 30% of the total thickness of the film; the first core layer has a thickness that is 15% of the thickness of the film; the third core layer has a thickness that is 10% of the thickness of the film; the second core layer has a thickness that is 15% of the thickness of the film; and the second outer layer has a thickness that is 30% of the thickness of the film. Comparative Example 14 is a technically a three-layer blown film where the core comprises the same polymer composition and the first outer layer has a thickness of 33% of the total thickness of the film; the first core layer has a thickness that is 34% of the thickness of the film; and the second outer layer has a thickness that is 33% of the thickness of the film.

TABLE 6
Blown Film Structures

| Example | First Outer | First Core | Third Core | Second Core | Second Outer |
|---|---|---|---|---|---|
| (Ex.) | Layer | Layer | Layer | Layer | Layer |
| Comp. | 100 wt. % | 100 wt. % | 100 wt. % | 100 wt. % | 70 wt. % |
| Ex. 9 | INNATE ™ | ELITE ™ | INNATE ™ | ELITE ™ | INNATE ™ |
| | ST50 | 5960G1 | ST70 | 5960G1 | ST50 + 30 wt. |
| | | | | | % DOW ™ 132I |
| | | | | | LDPE |
| Comp. | 100 wt. % | 50 wt. % | 100 wt. % | 50 wt. % | 100 wt. % |
| Ex. 10 | INNATE ™ | ELITE ™ | INNATE ™ | ELITE ™ | INNATE ™ |
| | ST50 | 5960G1 + 50 | ST70 | 5960G1 + 50 | ST50 |
| | | wt. % | | wt. % | |
| | | SURLYN ™ | | SURLYN ™ | |
| | | 1706 | | 1706 | |
| Comp. | 100 wt. % | 25 wt. % | 100 wt. % | 25 wt. % | 100 wt. % |
| Ex. 11 | INNATE ™ | ELITE ™ | INNATE ™ | ELITE ™ | INNATE ™ |
| | ST50 | 5960G1 + 75 | ST70 | 5960G1 + 75 | ST50 |
| | | wt. % | | wt. % | |
| | | SURLYN ™ | | SURLYN ™ | |
| | | 1706 | | 1706 | |
| Comp. | 100 wt. % | 100 wt. % | 100 wt. % | 100 wt. % | 100 wt. % |
| Ex. 12 | INNATE ™ | SURLYN ™ | INNATE ™ | SURLYN ™ | INNATE ™ |
| | ST50 | 1706 | ST70 | 1706 | ST50 |
| Comp. | 100 wt. % | 75 wt. % | 100 wt. % | 75 wt. % | 100 wt. % |
| Ex. 13 | INNATE ™ | ELITE ™ | INNATE ™ | ELITE ™ | INNATE ™ |
| | ST50 | 5960G1 + 25 | ST70 | 5960G1 + 25 | ST50 |
| | | wt. % Entira | | wt. % Entira | |
| | | MK 400 | | MK 400 | |
| Comp. | 100 wt. % | 70 wt. % | 70 wt. % | 70 wt. % | 70 wt. % |
| Ex. 14 | INNATE ™ | DOWLEX ™ | DOWLEX ™ | DOWLEX ™ | INNATE ™ |
| | ST50 | 2038.68G + 30 | 2038.68G + 30 | 2038.68G + 30 | ST50 + 30 wt. |
| | | wt. % | wt. % | wt. % | % DOW ™ 132I |
| | | DOWLEX ™ | DOWLEX ™ | DOWLEX ™ | LDPE |
| | | 2050 | 2050 | 2050 | |
| Inv. | 100 wt. % | 75 wt. % | 100 wt. % | 75 wt. % | 100 wt. % |
| Ex. 3 | INNATE ™ | ELITE ™ | INNATE ™ | ELITE ™ | INNATE ™ |
| | ST50 | 5960G1 + 25 | ST70 | 5960G1 + 25 | ST50 |
| | | wt. % | | wt. % | |
| | | SURLYN ™ | | SURLYN ™ | |
| | | 1706 | | 1706 | |
| Inv. | 100 wt. % | 75 wt. % | 100 wt. % | 75 wt. % | 100 wt. % |
| Ex. 4 | INNATE ™ | ELITE ™ | INNATE ™ | ELITE ™ | INNATE ™ |
| | ST50 | 5960G1 + 25 | ST70 | 5960G1 + 25 | ST50 |
| | | wt. % | | wt. % | |
| | | SURLYN ™ | | SURLYN ™ | |
| | | 1707 | | 1707 | |

The 2% Secant Modulus in cross direction (CD), 2% Secant Modulus in machine direction (MD), Dart Drop Impact Type B, Puncture Energy at Break, Elmendorf Tear in CD, and Elmendorf Tear in MD are measured for each of the blown film Comparative and Inventive Examples. Tables 7 and 8 below provide the results. As can be seen from Tables 7, the Inventive Examples have significantly better Puncture Energy at Break and Elmendorf Tear in the CD and MD than the Comparative Examples. The Inventive Examples also have a balance of other desirable properties.

TABLE 7
Properties of Comparative Blown Film Examples

| | Comp. | Comp. | Comp. | Comp. | Comp. | Comp. | Inv. | Inv. |
|---|---|---|---|---|---|---|---|---|
| | Ex. 9 | Ex. 10 | Ex. 11 | Ex. 12 | Ex. 13 | Ex. 14 | Ex. 3 | Ex. 4 |
| Thickness | 110 | 110 | 110 | 110 | 110 | 125 | 110 | 110 |
| (microns) | | | | | | | | |
| 2% Sec. | 357 | 340 | 308 | 255 | 482 | 309 | 378 | 351 |
| Modulus | | | | | | | | |
| CD (Mpa) | | | | | | | | |
| 2% Sec. | 352 | 365 | 299 | 233 | 453 | 287 | 360 | 343 |
| Modulus | | | | | | | | |
| MD (Mpa) | | | | | | | | |
| Dart Drop | 487 | 656 | 750 | 648 | 300 | 553 | 624 | 395 |
| Type B (g) | | | | | | | | |
| Puncture | 11.3 | 13.7 | 8.7 | 5.9 | 7.9 | 11.1 | 20.0 | 15.6 |
| Energy at | | | | | | | | |
| Break (J) | | | | | | | | |
| Elmendorf | 2087 | 416 | 298 | 264 | 1120 | 1886 | 2601 | 2233 |
| Tear CD (g) | | | | | | | | |
| Elmendorf | 1188 | 252 | 264 | 239 | 1057 | 1261 | 3583 | 2869 |
| Tear MD (g) | | | | | | | | |

Raman microscopy is used to measure the % crystallinity of the first core layer of certain of the example blown multilayer films. Table 8 reports the results.

TABLE 8
Raman Microscopy % Crystallinity of First Core Layer

| | | % Crystallinity in |
|---|---|---|
| Example | First Core Layer Composition | the Core Layer |
| Comp. Ex. 9 | 100 wt. % ELITE ™ 5960G1 | 71.29 |
| Comp. Ex. 12 | 100 wt. % SURLYN ™ 1706 | 23.58 |
| Inv. Ex. 3 | 75 wt. % ELITE ™ 5960G1 + | 56.83 |
| | 25 wt. % SURLYN ™ 1706 | |
| Inv. Ex. 4 | 75 wt. % ELITE ™ 5960G1 + | 60.97 |
| | 25 wt. % SURLYN ™ 1707 | |

1. A multilayer film comprising:
a first outer layer, a second outer layer, and a core, the core comprising one or more core layers, wherein a first core layer comprises from 5 to 45 wt. %, based on the total weight of the first core layer, of a zinc or sodium ionomer of ethylene acid copolymer and from 55 to 95 wt. %, based on the total weight of the first core layer, of a polyethylene having a density of from 0.950 to 0.970 g/cm³ and a melt index (I₂) of from 0.3 to 10.0 g/10 min; wherein the first core layer has a thickness of 5 to 40% of the total thickness of the multilayer film.

2. The multilayer film of claim 1, wherein the first outer layer and the second outer layer each comprise polyethylene.

3. The multilayer film of claim 1, wherein the multilayer film comprises greater than 80 wt. % ethylene-based polymers, based on the total weight of the multilayer film.

4. The multilayer film of claim 1, wherein the core comprises 100 wt. % ethylene-based polymers, based on the total weight of the core.

5. The multilayer film of claim 1, wherein the first core layer has a Raman measured % crystallinity of from 50% to 63%.

6. The multilayer film of claim 1, wherein a second core layer comprises from 5 to 45 wt. % of a zinc or sodium ionomer of ethylene acid copolymer and from 55 to 95 wt. % of a polyethylene having a density of 0.950 to 0.970 g/cm³, based on the total weight of the second core layer.

7. The multilayer film of claim 6, wherein a third core layer comprises a polyethylene having a melt index less than 7.0 g/10 min and density less than 0.940 g/cm³, and wherein the third core layer is positioned between the first core layer and the second core layer.

8. The multilayer film of claim 1, wherein the multilayer film is a cast stretch film having an ESTL tear greater than 0.4 s/micron.

9. The multilayer film of claim 1, wherein the multilayer film is a blown film having at least one of the following properties: a machine direction Elmendorf Tear Strength greater than 0.13 N/micron and/or a Dart Drop Impact B greater than 0.031 N/micron.

10. An article comprising the multilayer film of claim 1.

11. The multilayer film of claim 1, wherein the first core layer has a thickness of 5 to 20% of the total thickness of the multilayer film.

12. The multilayer film of claim 1, wherein the first outer layer or second outer layer comprises a high density polyethylene having a density greater than 0.950 g/cm³.
